(19) United States
(12) Patent Application Publication
(10) Pub. No.: US 2013/0234396 A1
(43) Pub. Date: Sep. 12, 2013

(54) Transition Piece Aft-Frame Seals

(71) Applicants: Christopher Paul Willis, Greenville, SC (US); Patrick Benedict Melton, Greenville, SC (US); John Alfred Simo, Simpsonville, SC (US)

(72) Inventors: Christopher Paul Willis, Greenville, SC (US); Patrick Benedict Melton, Greenville, SC (US); John Alfred Simo, Simpsonville, SC (US)

(73) Assignee: GENERAL ELECTRIC COMPANY, Schenectady, NY (US)

(21) Appl. No.: 13/416,496

(22) Filed: Mar. 9, 2012

(51) Int. Cl. F02C 7/28; F16J 15/02; F02C 7/12

(52) U.S. Cl. 277/312; 277/628

(57) ABSTRACT

A transition piece aft-frame seal assembly may include an elongate body including a first side and a second side. The seal assembly may also include at least one feed hole disposed on the first side of the body. The seal assembly may also include at least one passageway extending through the body from the first side to the second side and in communication with the at least one feed hole. Moreover, the seal assembly may include at least one cooling hole disposed at the second side of the body and in communication with the at least one passageway. A flow of cooling fluid may enter the at least one feed hole, the at least one passageway, and the at least one cooling hole, wherein the at least one cooling hole directs the flow of cooling fluid to a recirculation zone about adjacent transition piece aft-frame assemblies.

### FIELD OF THE DISCLOSURE

Embodiments of the present application relate generally to gas turbine engines and more particularly to combustor assemblies including transition piece aft-frame seals.

### BACKGROUND OF THE DISCLOSURE

In a conventional gas turbine, numerous combustors are disposed in an annular array about the axis of the machine. A compressor supplies compressed air to each combustor, wherein the compressed air and fuel are mixed and burned. Hot combustion gases may flow from each combustor through a transition piece to a first stage nozzle to drive the turbine and generate power. An aft-frame is typically attached to the downstream or aft end of the transition piece and generally includes a sealing element to prevent leakage of the hot gases at the interface between the transition piece and the first stage nozzle.

The aft end between adjacent transition piece aft-frames typically creates a low pressure region in which hot, low velocity gas may accumulate. This hot gas recirculation zone may lead to degraded aft-frame life through hardware cracking and oxidation.

### BRIEF DESCRIPTION OF THE DISCLOSURE

Some or all of the above needs and/or problems may be addressed by certain embodiments of the present application. According to one embodiment, there is disclosed a transition piece aft-frame seal assembly. The seal assembly may include an elongate body including a first side and a second side, at least one feed hole disposed on the first side of the body, at least one passageway extending through the body from the first side to the second side and in communication with the at least one feed hole, and at least one cooling hole disposed at the second side of the body and in communication with the at least one passageway. A flow of cooling fluid may enter the at least one feed hole, the at least one passageway, and the at least one cooling hole, wherein the at least one cooling hole directs the flow of cooling fluid to a recirculation zone about adjacent transition piece aft-frame assemblies.

According to another embodiment, there is disclosed a transition piece aft-frame seal assembly. The seal assembly may include a platform, a generally Y-shaped member extending from the platform, at least one feed hole disposed in the platform, at least one passageway extending from the at least one feed hole through the generally Y-shaped member, and at least one cooling hole disposed at a distal end of the generally Y-shaped member and in communication with the at least one passageway. A flow of cooling fluid may enter the at least one feed hole, the at least one passageway, and the at least one cooling hole, wherein the at least one cooling hole directs the flow of cooling fluid to a recirculation zone about adjacent transition piece aft-frame assemblies.

Further, according to another embodiment, there is disclosed a method. The method may include positioning a seal between adjacent transition piece aft-frame assemblies. The method may also include directing a flow of cooling fluid through the seal to a recirculation zone about the adjacent transition piece aft-frame assemblies.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a schematic of an example diagram of a gas turbine engine with a compressor, a combustor, and a turbine.

FIG. 2 is a cross-sectional view of a portion of a combustor assembly.

FIG. 3 is a perspective view of an example embodiment of a seal assembly, according to an embodiment.

FIG. 4 is a cross-sectional view of an example embodiment of a seal assembly, according to an embodiment.

FIG. 5 is a cross-sectional view of an example embodiment of a seal assembly, according to an embodiment.

FIG. 6 is a cross-sectional view of an example embodiment of a seal assembly, according to an embodiment.

FIG. 7 is an example flow diagram of a method, according to an embodiment.

### DETAILED DESCRIPTION OF THE DISCLOSURE

Illustrative embodiments will now be described more fully hereinafter with reference to the accompanying drawings, in which some, but not all embodiments are shown. The present application may be embodied in many different forms and should not be construed as limited to the embodiments set forth herein. Like numbers refer to like elements throughout.

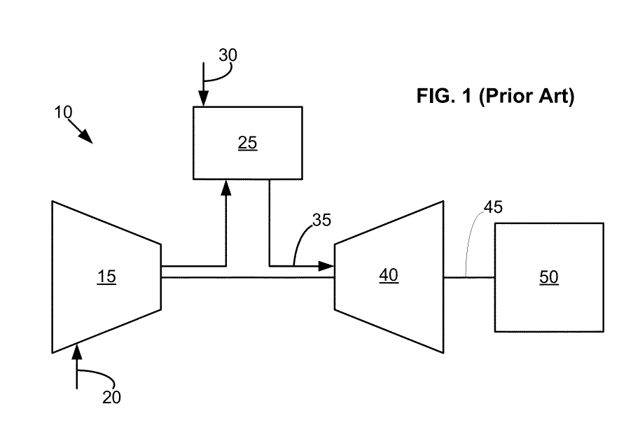

Illustrative embodiments are directed to, among other things, a combustor assembly including a trapped vortex cavity. FIG. 1 shows a schematic view of a gas turbine engine 10 as may be used herein. As is known, the gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components.

Other types of gas turbine engines also may be used herein. Multiple gas turbine engines, other types of turbines, and other types of power generation equipment also may be used herein together.

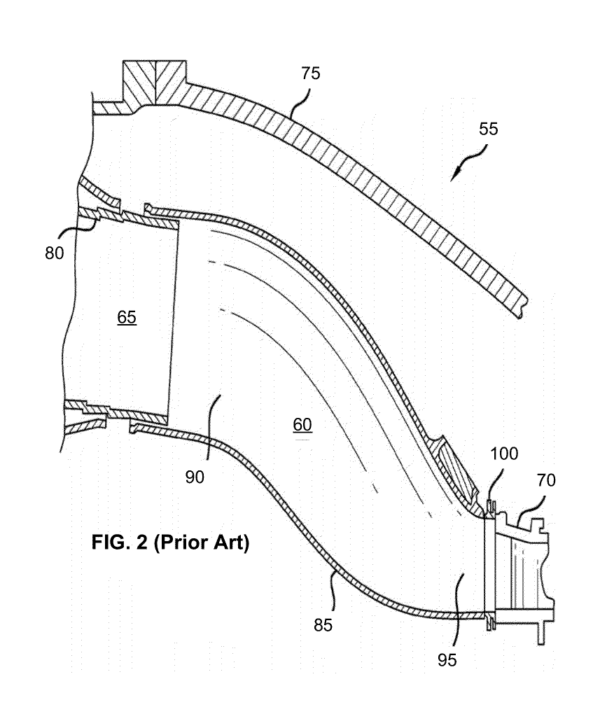

A cross-sectional view of a combustion system 55 is illustrated, for example, in FIG. 2. Components of the system 55 may include a transition piece 60 for enclosing and confining combustion products for flow from a combustor 65 of a gas turbine to a first stage nozzle 70. It should be appreciated that there may be an annular array of combustors for generating and flowing hot gases to an annular array of nozzles 70, one of each of such combustors 65, nozzles 70, and transition pieces 60 being illustrated. Also illustrated is a portion of the compressor discharge casing 75. Compressor discharge air is typically provided within the space between the casing 75 and the combustor liner 80 and transition piece 60 to cool combustion system components and as a source of dilution air.

As shown in FIG. 2, the transition piece 60 may include an enclosure 85 for confining and directing the flow of combustion products from the combustor 65 to the nozzle 70. Thus, the enclosure 85 includes a forward end 90 and an aft end 95 for respectively receiving the combustion products and flowing the combustion products in the direction of the nozzle 70. The forward end 90 of the transition piece 60 may be generally circular. In one embodiment, the transition piece 60 may transition from a circular forward end 90 generally axially and radially inwardly relative to the turbine axis and terminates in a slightly arcuate, generally rectilinear aft end 95. Located between the aft end 95 and the nozzle 70 is a typical aft-frame 100. The aft-frame 100 may be generally rectilinear in shape to match the shape of the aft end 95 of the transition piece 60 and may be typically attached to the transition piece 60 by welding the aft-frame 100 to the aft end 95.

As is generally understood in the art, the area between two adjacent transition piece aft-frames creates a low pressure region in which hot, low velocity gas may accumulate. This hot gas recirculation zone may lead to degraded aft-frame life through hardware cracking and oxidation. In certain embodiments, the present application provides a seal between adjacent transition piece aft-frames. The seal directs cooling air into the recirculation region and expels hot gas and/or reduces the bulk temperature. The seal may increase the life of the transition piece and decrease the amount of rework required at inspection and repair intervals.

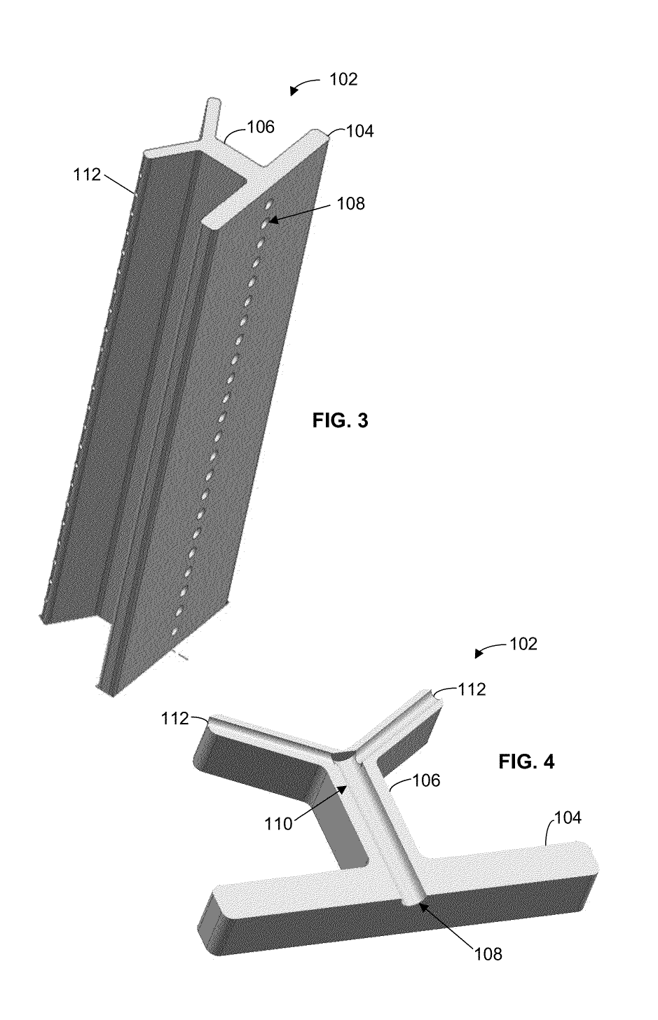

FIGS. 3 and 4 depict an example embodiment of a transition piece aft-frame seal assembly 102. The seal assembly 102 may include a platform 104. The seal assembly 102 may also include a generally Y-shaped member 106 extending from the platform 104. A number of feed holes 108 may be disposed in the platform 104. The feed holes 108 may be in communication with a respective passageway 110 that extends from the feed holes 108 through the generally Y-shaped member 106. The seal assembly 102 may also include a number of cooling holes 112 disposed at a distal end of the generally Y-shaped member 106. The cooling holes 112 may be in communication with a respective passageway 110.

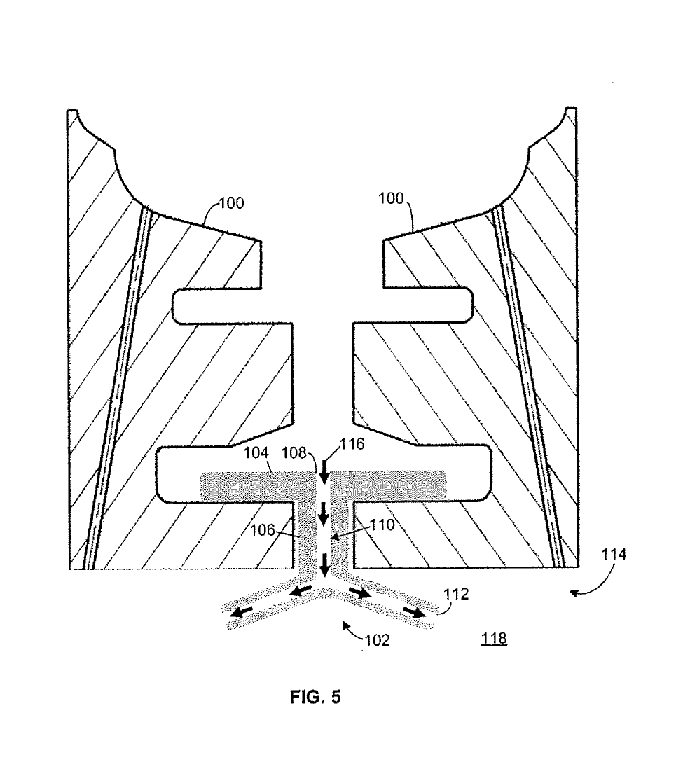

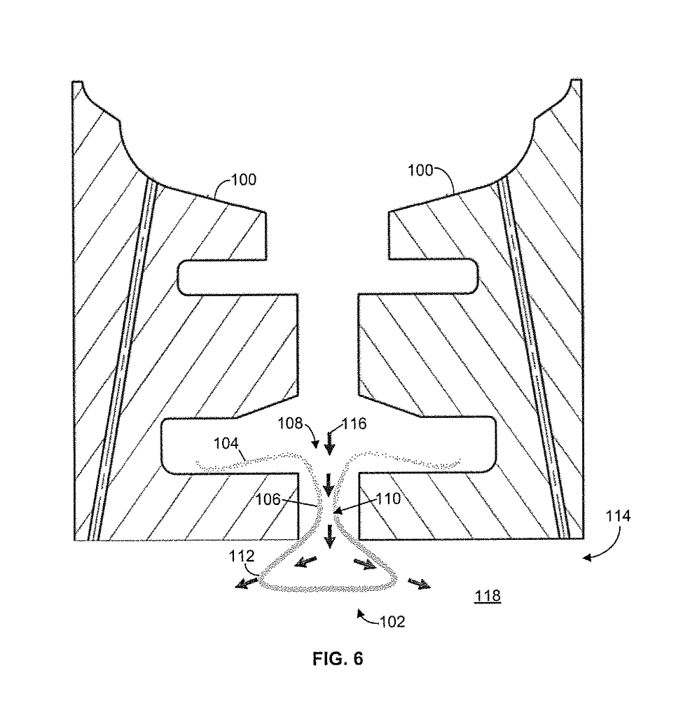

As depicted in FIG. 5, the seal assembly 102 may be disposed between adjacent transition piece aft-frame assemblies 100. Specifically, the platform 104 may extend between the adjacent transition piece aft-frame assemblies 100 to form a seal. In certain aspects, a flow of cooling fluid 116 may pass between the adjacent transition piece aft-frame assemblies 100 and enter the feed holes 108 of the seal assembly 102. The flow of cooling fluid 116 may pass through the passageway 110 and exit the cooling holes 112. The cooling holes 112 may be angled to direct the flow of cooling fluid 116 to a recirculation zone 118 about an aft end 114 of the adjacent transition piece aft frame assemblies 100. For example, the cooling holes 112 may be angled to direct the flow of cooling fluid 116 to the recirculation zone 118 to expel hot gases that accumulate in the recirculation zone 118.

The angle of the cooling holes 112 may be dictated by the configuration of the seal assembly 102. For example, as depicted in FIG. 5, the generally Y-shaped member 106 angles the cooling holes 112 about 40 degrees with respect to the aft end 114 of the adjacent transition piece aft frame assemblies 100. One will appreciate, however, that the angle of the cooling holes 112 may be greater than, equal to, or less than 40 degrees depending on the configuration of the gas turbine and the recirculation zone 118. In fact, the cooling holes 112 may be any angle. The angle of the cooling holes 112 facilitates the expulsion of hot gases that accumulate in the recirculation zone 118.

Still referring to FIG. 5, the platform 104, the generally Y-shaped member 106, the feed holes 108, the passageways 110, and the cooling holes 112 may include a single machined piece. In another embodiment, as depicted in FIG. 6, the platform 104, the generally Y-shaped member 106, the feed holes 108, the passageways 110, and the cooling holes 112 may include a single formed piece. One will appreciate, however, that the seal assembly 102 may include a variety of shapes and sizes. For example, the seal assembly 102 may be any configuration that directs the flow of cooling fluid 116 to the recirculation zone 118 to expel hot gases that accumulate in the recirculation zone 118. Any number of feed holes 108, passageways 110, and cooling holes 112 may be included to expel hot gases that accumulate in the recirculation zone 118.

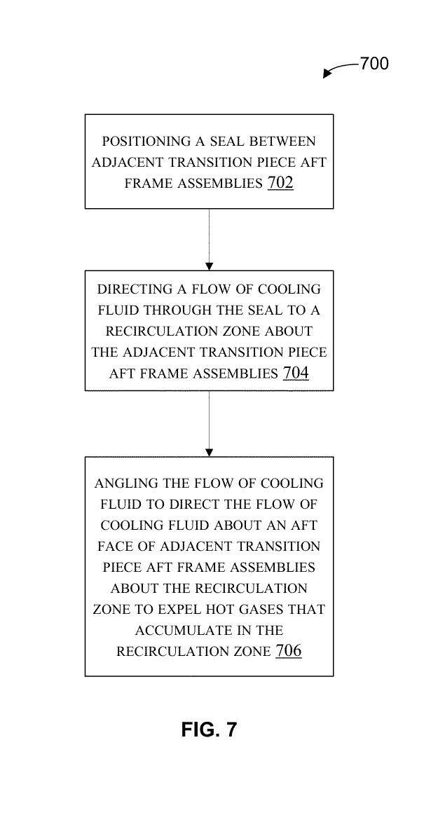

FIG. 7 illustrates an example flow diagram of a method 700 for directing a flow of cooling fluid to a recirculation zone about an aft end of the adjacent transition piece aft frame assemblies 114. In this particular embodiment, the method 700 may begin at block 702 of FIG. 7 in which the method 700 may include positioning a seal between adjacent transition piece aft-frame assemblies. At block 704, the method may include directing a flow of cooling fluid through the seal to a recirculation zone about the adjacent transition piece aft-frame assemblies. Moreover, at block 706, the method 700 may include angling the flow of cooling fluid to direct the flow of cooling fluid about an aft face of adjacent transition piece aft frame assemblies about the recirculation zone to expel hot gases that accumulate in the recirculation zone.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A transition piece aft-frame seal assembly, comprising:
an elongate body comprising a first side and a second side;
at least one feed hole disposed on the first side of the body;
at least one passageway extending through the body from the first side to the second side and in communication with the at least one feed hole; and
at least one cooling hole disposed at the second side of the body and in communication with the at least one passageway,
wherein a flow of cooling fluid enters the at least one feed hole, the at least one passageway, and the at least one cooling hole, and wherein the at least one cooling hole directs the flow of cooling fluid to a recirculation zone about adjacent transition piece aft-frame assemblies.

2. The seal assembly of claim 1, wherein the at least one cooling hole is angled to direct the flow of cooling fluid to the recirculation zone to expel hot gases that accumulate in the recirculation zone.

3. The seal assembly of claim 1, wherein the at least one cooling hole is angled to direct the flow of cooling fluid about an aft face of adjacent transition piece aft-frame assemblies about the recirculation zone to expel hot gases that accumulate in the recirculation zone.

4. The seal assembly of claim 1, wherein the body extends between adjacent transition piece aft-frame assemblies to form a seal.

5. The seal assembly of claim 1, wherein the at least one feed hole comprises a plurality of feed holes.

6. The seal assembly of claim 1, wherein the at least one passageway comprises a plurality of passageways.

7. The seal assembly of claim 1, wherein the at least one cooling hole comprises a plurality of cooling holes.

8. A transition piece aft-frame seal assembly, comprising:
a platform;
a generally Y-shaped member extending from the platform;
at least one feed hole disposed in the platform;
at least one passageway extending from the at least one feed hole through the generally Y-shaped member; and
at least one cooling hole disposed at a distal end of the generally Y-shaped member and in communication with the at least one passageway;
wherein a flow of cooling fluid enters the at least one feed hole, the at least one passageway, and the at least one cooling hole, and wherein the at least one cooling hole directs the flow of cooling fluid to a recirculation zone about adjacent transition piece aft-frame assemblies.

9. The seal assembly of claim 8, wherein the at least one cooling hole is angled to direct the flow of cooling fluid to the recirculation zone to expel hot gases that accumulate in the recirculation zone.

10. The seal assembly of claim 8, wherein the at least one cooling hole is angled to direct the flow of cooling fluid about an aft face of adjacent transition piece aft-frame assemblies about the recirculation zone to expel hot gases that accumulate in the recirculation zone.

11. The seal assembly of claim 8, wherein the platform extends between the adjacent transition piece aft-frame assemblies to form a seal.

12. The seal assembly of claim 8, wherein the at least one feed hole comprises a plurality of feed holes.

13. The seal assembly of claim 8, wherein the at least one passageway comprises a plurality of passageways.

14. The seal assembly of claim 8, wherein the at least one cooling hole comprises a plurality cooling hole pairs.

15. The seal assembly of claim 8, wherein the at least one cooling hole comprises one or more pairs of cooling hole pairs disposed at the distal end of the generally Y-shaped member.

16. The seal assembly of claim 8, wherein the platform, the generally Y-shaped member, the at least one feed hole, the at least one passageway, and the at least one cooling hole comprises a single machined piece.

17. The seal assembly of claim 8, wherein the platform, the generally Y-shaped member, the at least one feed hole, the at least one passageway, and the at least one cooling hole comprises a single formed piece.

18. A method, comprising:
positioning a seal between adjacent transition piece aft-frame assemblies;
directing a flow of cooling fluid through the seal to a recirculation zone about the adjacent transition piece aft-frame assemblies.

19. The method of claim 18, further comprising angling the flow of cooling fluid at the recirculation zone to expel hot gases that accumulate in the recirculation zone.

20. The method of claim 18, further comprising angling the flow of cooling fluid to direct the flow of cooling fluid about an aft face of adjacent transition piece aft-frame assemblies about the recirculation zone to expel hot gases that accumulate in the recirculation zone.
